(19) United States
(12) Patent Application Publication
(10) Pub. No.: US 2008/0239713 A1
(43) Pub. Date: Oct. 2, 2008

(54) SOLAR DOOR LIGHTING SYSTEM

(75) Inventors: Lee W. Davis, Holland, MI (US); Richard L. Horner, Grand Haven, MI (US)

Correspondence Address: WARNER NORCROSS & JUDD LLP, 900 FIFTH THIRD CENTER, 111 LYON STREET, N.W., GRAND RAPIDS, MI, 49503-2487, US

(73) Assignee: ODL, Incorporated, Zeeland, MI (US)

(21) Appl. No.: 11/694,166

(22) Filed: Mar. 30, 2007

(51) Int. Cl. F21L 4/08

(52) U.S. Cl. 362/183

(57) ABSTRACT

A self-contained, solar-powered light fixture for illuminating the exterior of a building door. The fixture includes a light source, a rechargeable battery, and a solar collector. The collector charges the battery when ambient light is relatively high (i.e. during the day), and the battery powers the light when ambient light is relatively low (i.e. during the night). The solar collector is removable from the fixture, enabling the solar collector be mounted in a location separate from the fixture.

### BACKGROUND OF THE INVENTION

The present invention relates to exterior lighting systems and more particularly to solar-powered exterior lighting systems.

The exterior lighting of building doors and entranceways is a common and useful practice. Such lighting enhances safety, allows inhabitants to view who is at the door before opening the door and enhances the aesthetic appeal of the residence or other building.

In locations where no exterior light has previously been installed, installing a retrofit exterior light is typically beyond the skill set of the average do-it-yourselfer. Such an installation requires cutting holes in the building exterior and extending electrical service to the desired installation site. Thus, the average person likely would need to retain a professional contractor at a relatively high cost to install an exterior light.

### SUMMARY OF THE INVENTION

The aforementioned problems are overcome by the present invention comprising a self-contained, solar-powered, battery-operated lighting fixture. The fixture can be mounted on a building door or on a building in an area adjacent the door. In a first embodiment, the light source, the solar collector and the battery are contained within a common housing.

The present invention has several advantages over traditional exterior lights. Most notably, the fixture can be easily installed by a homeowner or other do-it-yourselfer without the need to cut holes in the building or to extend electrical service. This greatly reduces the cost of providing exterior lighting.

In a current embodiment, the lighting system includes a solar collector that is removable from the fixture housing, enabling the collector to be located in a different location. This embodiment enables the collector to be located in a location receiving more ambient light than the location of the fixture, for example when the fixture is located under a roof overhang, a soffit, an awning or other shaded area.

These and other objects, advantages, and features of the invention will be fully understood and appreciated by reference to the description of the current embodiments and the drawings.

### BRIEF DESCRIPTION OF THE DRAWINGS

FIG. 1 is a perspective view of the solar door lighting system installed on a building over a door.

FIG. 2 is an enlarged perspective view of the area within line 2 of FIG. 1.

FIG. 3 is a top perspective view of the solar door lighting system.

FIG. 4 is a bottom perspective view of the solar door lighting system.

FIG. 5 is an exploded perspective view of the solar door lighting system.

FIG. 6 is an end view of the solar door lighting system with the end cap removed.

FIG. 7 is an electrical schematic of the circuit of the solar door lighting system.

FIG. 8 is a perspective view of the door lighting system with the solar collector installed separate from the housing.

FIG. 9 is a perspective view of the solar collector.

FIG. 10 is a perspective view of the solar door lighting system with the solar collector removed from the housing.

### DESCRIPTION OF THE CURRENT EMBODIMENTS

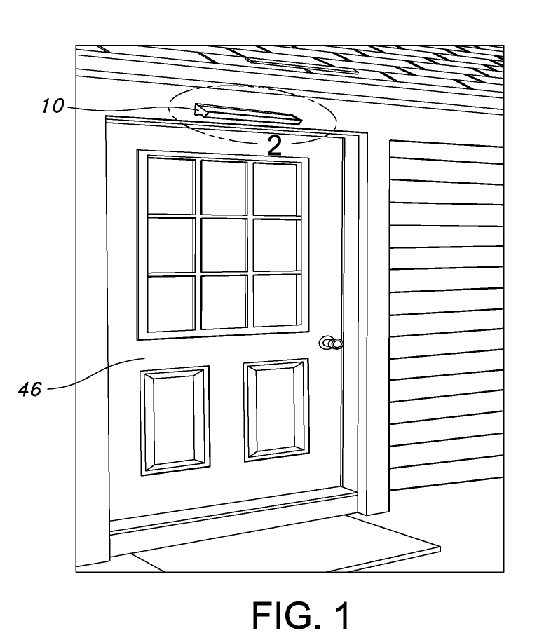

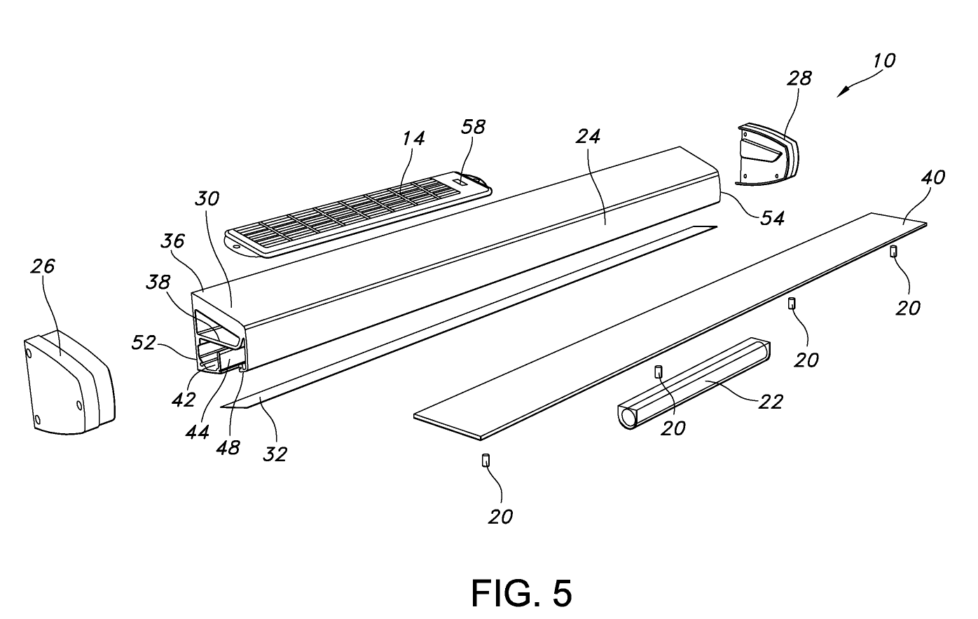

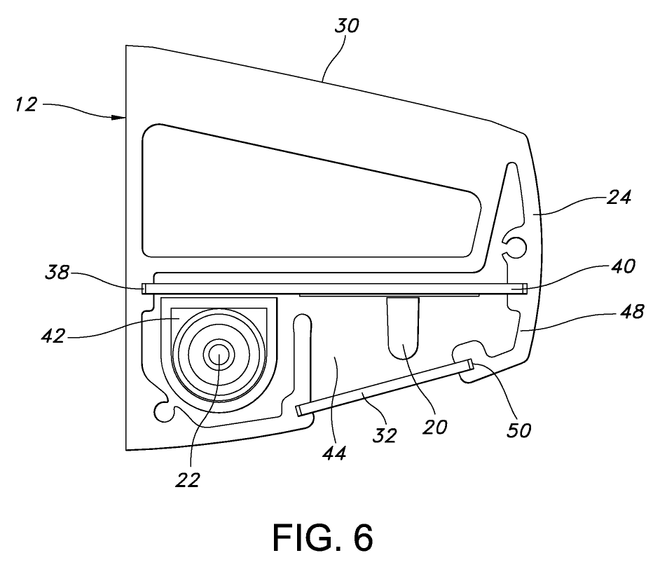

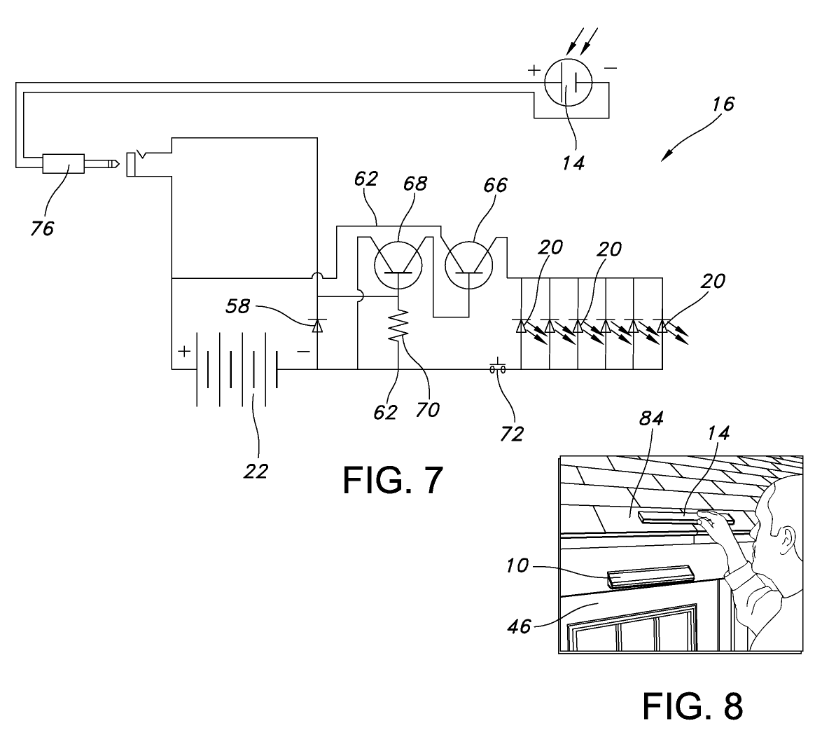

A solar door lighting system constructed in accordance with a first embodiment of the invention is illustrated in FIGS. 1-10 and generally designated 10. The system includes a housing 12, a light source 20, a power source 22, a solar collector 14 and a circuit 16. The circuit 16 controls the operation of the light source 20 and the recharging of the power source 22.

### I. Housing

The housing 12 provides a weather-tight enclosure for the light source 20, power source 22 and circuit 16. The housing 12 includes a main housing body 24, a first end cap 26, a second end cap 28 and a light source window or lens 32. The first end cap 26 interfits with the housing body 24 at a first end 52 of the housing body 24. The second end cap 28 interfits with the housing body 24 at a second opposite end 54 of the housing body 24. The end caps 26 and 28 may be secured to the housing body 24 using a press fit, a snap fit, adhesive, fasteners such as screws or clips and/or any other suitable connection means.

The current configuration of the housing 12 is illustrated in the drawings. The housing 12 could be constructed in other configurations. In the current embodiment, the main housing body 24 is an aluminum extrusion; and the first end cap 26 and the second end cap 28 are injection molded plastic. These components could be constructed from any material providing suitable performance and aesthetics, including metal or wood.

The main housing body 24 has a solar collector support surface 30. The solar collector 14 may be secured to the solar collector support surface 30 using pressure sensitive adhesive tape or any other suitable attachment means, such as screws, an interference fit, and/or a snap fit. The solar collector support surface 30 is oriented away from the mounting surface so that the surface 30 is exposed to ambient light when the unit 10 is installed.

The circuit 16 is implemented on a circuit board 40. The main housing body 24 includes a circuit site 38 that receives and supports the circuit board 40. Alternatively, the circuit site 38 may be located in any other suitable location within the main housing body 24.

The power source 22 is a battery contained within the housing 12. The main housing body 24 includes a battery compartment 42 in which the battery is located and retained.

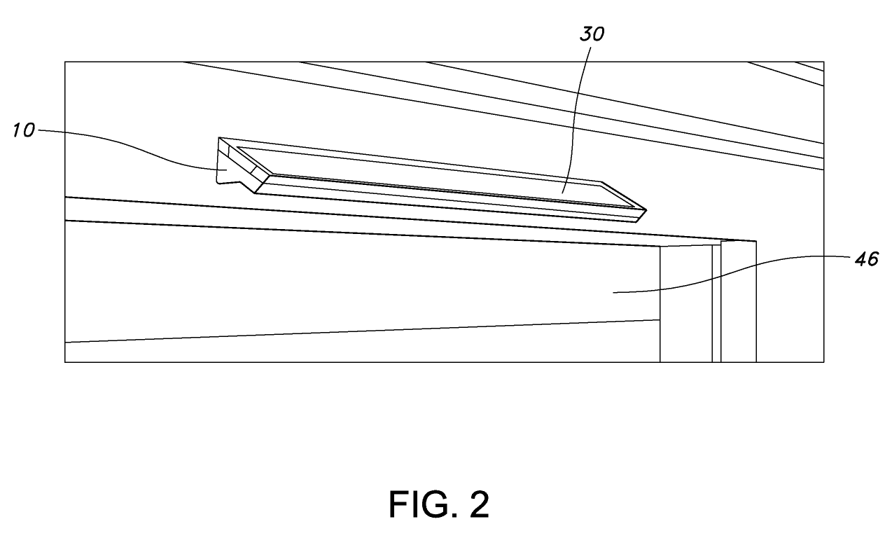

The main housing body 24 has a light source chamber 44 where the light source 20 is mounted. The light source chamber 44 is located so that the light source 20 will illuminate a door 46 and/or the area surrounding the door when the lighting system 10 is installed on or in proximity to the door 46. See FIGS. 1-2. The light source chamber 44 includes a valence 48 that projects from the main housing body 24 to assist in directing the light onto the door and to reduce the light that might shine into the eyes of a person approaching the door.

The main housing body 24 also defines a light source window slot 50 adjacent to the light source chamber 44. The light source window slot 50 receives the light source window or lens 32 through which light from the light sources 20 passes. The light source window 32 is fabricated of acrylic plastic or any other suitable transparent or translucent material. In the current embodiment, the material has a 93% light transmittance and a refractive index of 1.49.

### II. Solar Collector

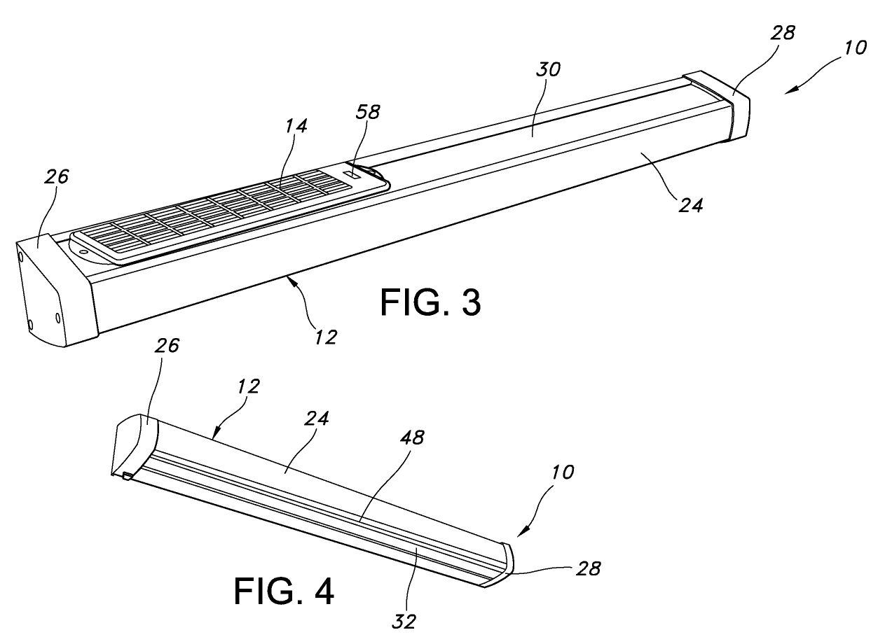

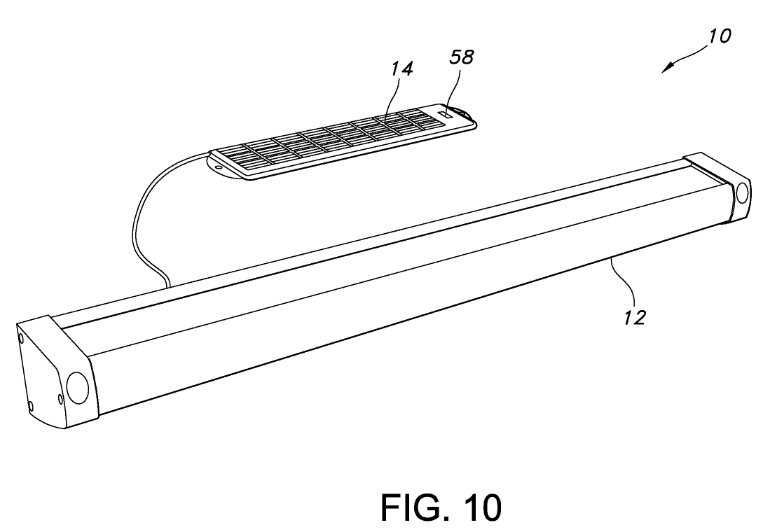

During installation (to be described), the solar collector 14 may either be attached to the solar collector support surface 30 of the main housing body 24 or installed separate from the housing body 24. See FIGS. 3 and 10. Various suitable solar collectors will be well known to those skilled in the art. In the first embodiment, the solar collector 14 is a thin panel and includes a 5 volt (V), 200 milliamp (mA) solar cell supported on an injection molded plastic panel. The solar collector 14 converts light energy to electrical energy. The circuit 16 includes a connector jack 76; and the solar collector 14 includes a plug removably received within the jack 76. A photodiode 58 is integrated into the solar collector 14.

### III. Rechargeable Power Source or Battery

The rechargeable power source or battery 22 1) receives and stores electrical power from the solar collector 14 and 2) supplies electrical power to the light source 20 through the circuit 16. The current rechargeable power source 22 is three 1300 milliamp-hour (mAh) 1.2 volt (V) nickel-metal hydride (Ni-MH) rechargeable batteries. Other power sources can be utilized as will be recognized by those skilled in the art.

### IV. Light Source

The current light source 20 is one or more light emitting diodes (LEDs). Alternatively, the light source 20 may be one or more other illuminators as will be recognized by those skilled in the art. In the current embodiment, the light source 20 includes four 10,000 millicandle (mCD) LEDs (light-emitting diodes).

### V. Circuit

The circuit 16 controls the charging of the battery 22 and the illumination of the light source 20. Appropriate electrical wiring 62 interconnects the circuit 16 to the solar collector 14, the light source 20 and the battery 22.

As noted above, the solar collector 14 converts light energy to electrical energy. The presence of ambient light on the collector 14 causes electrical energy or power to be supplied both to the battery 22 and to the light source 20 (depending on the state of the photodiode 58).

The photocell or photodiode 58 is responsive to the ambient light to turn off the light source 20 “during the day” or when the ambient light is relatively high. Specifically, the photodiode 58 is conductive when the ambient light is above a threshold level and is nonconductive when the ambient light is below the threshold level. Consequently, when the amount of ambient light striking the photocell 58 is relatively high, the photocell 58 turns off the light source 20 by turning off the transistors 66 and 68. Conversely, when the amount of ambient light striking the photocell 58 is relatively low, the photocell turns on the light source 20 by turning on the transistors 66 and therefore 68.

The circuit 16 can be of any configuration providing the desired performance. Those skilled in the art will recognize numerous circuit configurations utilizing various components that will provide suitable performance for the current invention. One such configuration includes the photodiode 58, a PNP transistor 66, an NPN transistor 68, a 100 kilo-ohm (K) resistor 70, and a pair of double-pole, double-throw (DPDT) switches 72.

### Installation

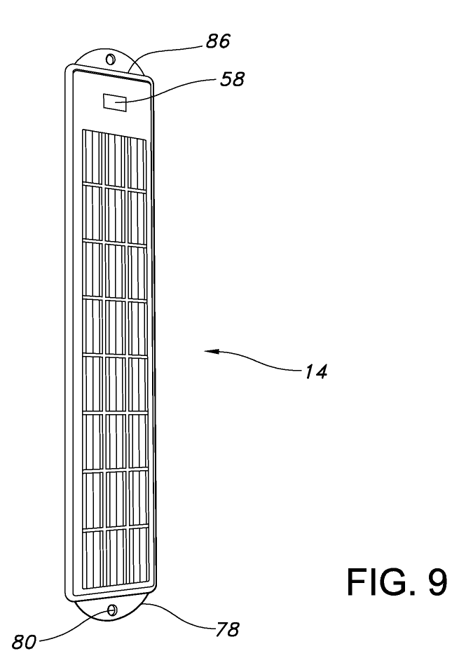

The system 10 may be installed in multiple ways as will be recognized by those skilled in the art. For example, the system 10 could be installed using brackets, fasteners, double-sided tape, adhesive or any other suitable attachment means (not shown). Alternatively, the system 10 could be installed directly on the door or the building using any of the aforementioned attachment means. For example, the solar collector 14 could be installed using mounting tabs 78 defining mounting holes 80 (FIG. 9). The mounting tabs 78 also define a score line 86 where the tab meets the solar collector 14 to facilitate removal of the mounting tabs 78 if they are not desired.

The system 10 can be installed in any location to illuminate a building opening 46 such as a door or a window. As illustrated in FIGS. 1-2, the system 10 is installed above an exterior door 46. If the installed system 10 receives adequate ambient daylight, the solar collector 14 can be affixed to the solar collector support surface 30 of the housing 12 using pressure sensitive tape or other fastening means. However, if the installed housing 24 is shielded by an overhang or does not otherwise receive adequate ambient light, the solar collector 14 may be removed from the housing and installed in a location separate from the housing 12. One such location, illustrated in FIG. 8, is on the roof 84 above the door 46.

The above description is that of the current embodiments of the invention. Various alterations and changes can be made without departing from the spirit and broader aspects of the invention as defined in the appended claims, which are to be interpreted in accordance with the principles of patent law including the doctrine of equivalents. Any reference to claim elements in the singular, for example, using the articles “a,” “an,” “the” or “said,” is not to be construed as limiting the element to the singular.

1. A solar door lighting system comprising:
a housing adapted to be mounted on at least one of a building and a building door to illuminate the door;
a rechargeable power source supported by the housing;
a solar collector;
a light source supported by the housing; and
a circuit supported by the housing and operatively connected to said power source, said solar collector, and said light source, said circuit supplying electrical energy from said solar collector to at least one of said rechargeable power source and said light source and from said rechargeable power source to said light source.

2. The solar door lighting system of claim 1 wherein said solar collector is supported by said housing.

3. The solar door lighting system of claim 1 wherein said solar collector is separate from said housing.

4. The solar door lighting system of claim 1 wherein said circuit includes a connector jack enabling said solar collector to be connected to said circuit.

5. The solar door lighting system of claim 1 wherein said housing includes a valence, said light source being located behind said valence to reduce amount of light from said light source shining into the eyes of a person approaching the door.

6. The solar door lighting system of claim 1 further comprising a photocell responsive to ambient light, the photocell turning on the light source only when the ambient light is relatively low.

7. A building assembly comprising:
a building;
a building opening; and
a lighting unit mounted on at least one of said building and said building opening to illuminate said building opening, said lighting unit comprising:
a solar collector;
a rechargeable power source;
a light source; and
a circuit interconnecting said solar collector, said rechargeable power source, and said light source.

8. The building assembly of claim 7 wherein said circuit includes a connector jack connecting said solar collector to said circuit.

9. The building assembly of claim 7 further comprising a housing supporting said solar collector, said power source, said light source, and said circuit, said housing including a valence projecting beyond said light source such that light emitted from said light source does not shine in the eyes of a person approaching the building opening.

10. The building assembly of claim 9 wherein said solar collector is removable from said housing.

11. A solar door lighting system comprising:
a housing having a valence projecting therefrom;
a rechargeable power source supported by said housing;
a plurality of light sources powered by said rechargeable power source and supported by said housing, said valence projecting beyond said light sources;
a solar collector; and
a connector jack removably electrically connecting said solar collector to said rechargeable power source.

12. The solar door lighting system of claim 11 wherein said solar collector is removable from said housing.
